(19) United States
(12) Patent Application Publication
(10) Pub. No.: US 2008/0084638 A1
(43) Pub. Date: Apr. 10, 2008

(54) Material Selection for a Suspension Assembly

(75) Inventor: Wayne Allen Bonin, North Oaks, MN (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: SEAGATE TECHNOLOGY LLC, Scotts Valley, CA (US)

(21) Appl. No.: 11/539,688

(22) Filed: Oct. 9, 2006

(51) Int. Cl. G11B 5/48

(52) U.S. Cl. 360/244.8

(57) ABSTRACT

A suspension assembly is disclosed having a base, a load beam region and a spring region. The spring region is positioned between the base and the load beam region. The spring region includes a material having a ratio of modulus of elasticity to yield strength that is less than 100.

### FIELD OF THE INVENTION

The present invention relates generally to data storage systems, and more particularly but not by limitation to a spring region of a suspension for a data storage system.

### BACKGROUND OF THE INVENTION

A typical data storage system includes a housing that encloses a variety of components. For example in a disc drive, the components include at least one rotating disc having data on one or more surfaces that are coated with a medium for storage of digital information in a plurality of circular, concentric data tracks. The disc(s) are mounted on a spindle motor that causes the disc(s) to spin and the data surfaces of the disc(s) to pass under respective bearing slider surfaces. The sliders carry transducers, which write information to and read information from the data surfaces of the disc(s). An actuator mechanism moves the sliders from track to track across the surfaces of the discs under control of electronic circuitry. The actuator mechanism includes a track accessing arm and a suspension for each slider.

The suspension includes a base, a spring region, a load beam and a gimbal (or flexure). The base connects the suspension to the track accessing arm. The spring region is located between the base and the load beam and provides flexibility for following the undulations on the disc surface. The spring region also provides a preload force of which the load beam transfers to the slider to force the slider towards the disc surface. The load beam is a stiffened structure such that a majority of deflection occurs in the spring region, while at the same time minimizing the mass of the load beam. The gimbal is configured to couple the slider to the load beam. Therefore, the gimbal is positioned between the slider and the load beam, or is integrated in the load beam, to provide a resilient connection that allows the slider to pitch and/or roll while following the topography of the disc.

In order to support the continued demand for ever increasing storage capacity in disc drives there is a continued increase in the recorded track density in disc drives. When the recorded track density in a disc drive is increased, the accuracy and response speed of positioning the transducers on the recorded tracks also needs to be increased. One limitation in positioning the transducers on the recorded tracks includes unwanted flexibility in the suspension. The suspension should easily flex up and down (along a z-axis or vertical direction) to allow the slider to follow the small undulations in the disc as the disc rotates, but it should also be as stiff as possible in all other directions, so that it does not deflect sideways during positioning of the transducers on the track. Any such flexibility limits the operational bandwidth at which the transducers are positioned.

### SUMMARY OF THE INVENTION

A suspension assembly is disclosed that includes a base, a load beam region and a spring region positioned between the base and the load beam region. In one embodiment, the spring region includes a material having a ratio of modulus of elasticity to yield strength that is less than 100. In another embodiment, the spring region is at least partially formed of a metallic glass.

A suspension assembly is also disclosed that includes a base and a load beam region. The load beam region includes a first material having a first ratio of modulus of elasticity to yield strength. The suspension assembly also includes a spring region positioned between the base and the load beam region. The spring region includes a second material having a second ratio of modulus of elasticity to yield strength. The second ratio of the second material is less than the first ratio of the first material.

Other features and benefits that characterize embodiments of the present invention will be apparent upon reading the following detailed description and review of the associated drawings.

### BRIEF DESCRIPTION OF THE DRAWINGS

FIG. 1 is an exploded perspective view of a disc drive.

FIG. 2 illustrates a top plan view of an embodiment of a suspension assembly.

FIG. 3 illustrates a bottom perspective view of another embodiment of a suspension assembly.

FIG. 4 illustrates a bottom plan view of the suspension assembly of FIG. 3 in a sway mode.

FIG. 5 illustrates a bottom perspective view of the suspension assembly of FIG. 3 in a bending mode.

FIG. 6 illustrates a bottom perspective view of the suspension assembly of FIG. 3 in a torsion mode.

FIG. 7 is a plot illustrating the relationship between yield strength or fracture strength and Young's modulus of elasticity for conventional crystalline metals and metallic glasses.

### DETAILED DESCRIPTION OF ILLUSTRATIVE EMBODIMENTS

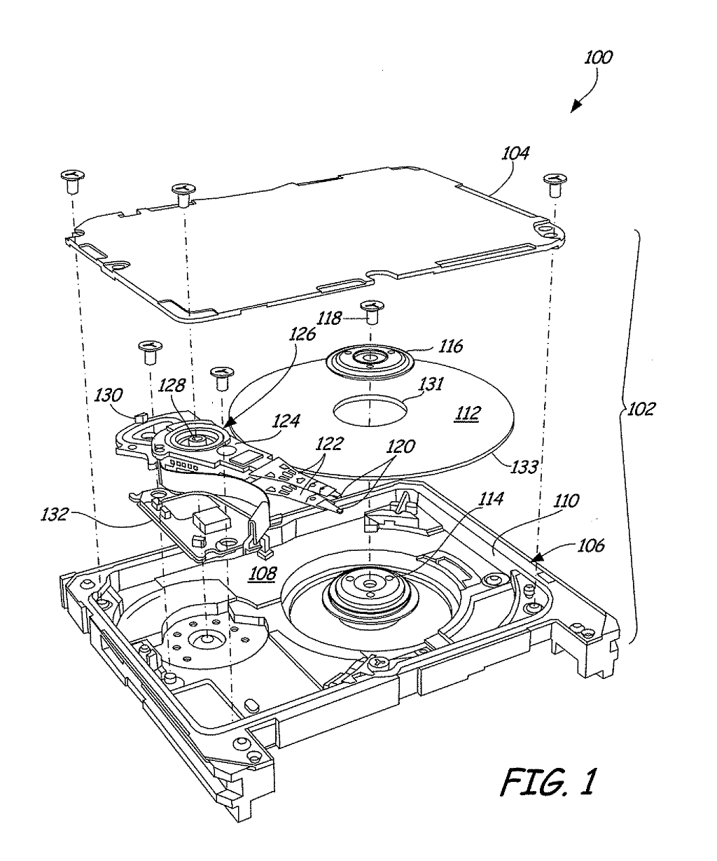

FIG. 1 is an exploded perspective view of a disc drive 100 in which embodiments of the present invention are useful. Disc drives are common data storage systems. One or more embodiments of the present invention are also useful in other types of data storage and non-data storage systems.

Disc drive 100 includes a housing 102 having a cover 104 and a base 106. As shown, cover 104 attaches to base 106 to form an enclosure 108 enclosed by a perimeter wall 110 of base 106. The components of disc drive 100 are assembled to base 106 and are enclosed in enclosure 108 of housing 102. As shown, disc drive 100 includes a disc or medium 112. Although FIG. 1 illustrates medium 112 as a single disc, those skilled in the art should understand that more than one disc can be used in disc drive 100. Medium 112 stores information in a plurality of circular, concentric data tracks and is mounted on a spindle motor assembly 114 by a disc clamp 116 and pin 118. Spindle motor assembly 114 rotates medium 112 causing its data surfaces to pass under respective bearing slider surfaces. Each surface of medium 112 has an associated slider 120, which carries transducers that communicate with the surface of the medium.

In the example shown in FIG. 1, sliders 120 are supported by suspension assemblies 122, which are, in turn, attached to track accessing arms 124 of an actuator mechanism 126. Actuator mechanism 126 is rotated about a shaft 128 by a voice coil motor 130, which is controlled by servo control circuitry within circuit 132. Voice coil motor 130 rotates actuator mechanism 126 to position sliders 120 relative to desired data tracks, between a disc inner diameter 131 and a disc outer diameter 133.

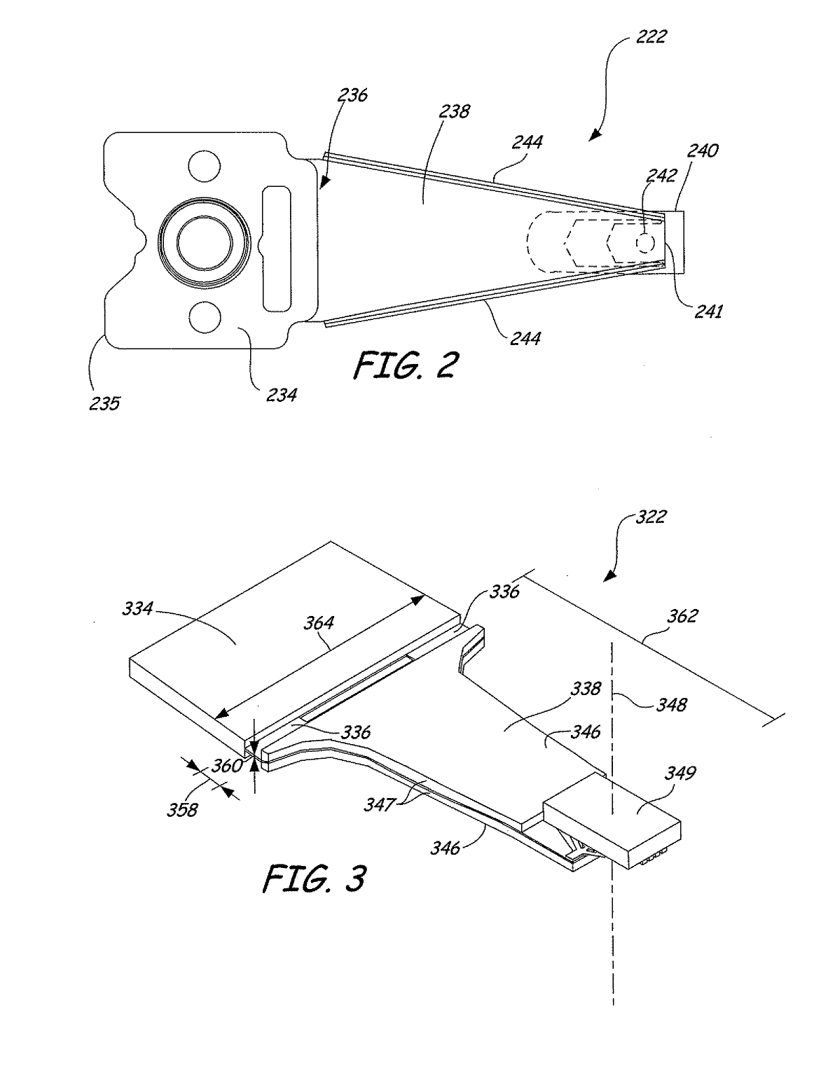

FIG. 2 illustrates a top plan view of an example suspension assembly 222 in which embodiments of the disclosure can be used. Suspension assembly 222 includes a base 234 located at a proximal end 235, a spring region 236, a load beam region 238, a gimbal 240 located at a distal end 241 and a slider (hidden from view in FIG. 2) coupled to the gimbal 240. Base 234 connects suspension assembly 222 to a track accessing arm, such as track accessing arm 124 of FIG. 1. Spring region 236 is located between base 234 and load beam region 238 and provides flexibility for following the topography of a medium surface, such as the surface of medium 112 of FIG. 1. Spring region 236 also provides a pre-load force onto the slider to force the slider towards the surface of the medium. Load beam region 238 connects spring region 236 to gimbal 240 and transmits the pre-load force from spring region 236 to the slider. Generally, load beam region 238 transmits the pre-load force to the slider through a load point 242 formed in load beam region 238. Gimbal 240 is configured to couple the slider to load beam region 238. Gimbal 240 can be positioned between the slider and load beam region 238 as illustrated in FIG. 2, or can be integrated into the load beam region, to provide a resilient connection that allows the slider to pitch and/or roll while following the topography of the disc.

In some embodiments, the suspension assembly, such as suspension assembly 222 illustrated in FIG. 2 includes load beam region 238 having a bent rail construction where the side edges 244 of the load beam region 238 are bent out-of-plane with respect to the main body of the suspension assembly. The bent rail construction stiffens load beam region 238 such that a majority of the deflection occurs in spring region 236, while simultaneously, the mass of load beam region 238 is minimized. In other embodiments, the suspension assembly, such as example suspension assembly 322 illustrated as a bottom perspective view in FIG. 3, includes a laminated load beam construction. The laminated load beam construction of suspension assembly 322 is a monocoque construction that includes a load beam region 338 having a pair of metallic outer skins 346 and a core 347. Core 347 can be made of a lightweight material or can be hollow to create a lighter and stiffer load beam region 338 than that of other laminated constructions and that of load beam region 238 of suspension assembly 222 in FIG. 2. The monocoque load beam construction, as illustrated exemplarily in FIG. 3, provides deflection in load beam region 338 that is relatively small compared to the deflection of spring region 336. As illustrated in FIG. 3, the material of spring region 336 is illustrated as extending between the metallic outer skins 346 of load beam region 338 for convenience of manufacture to support core 347. It should be noted, however, that this construction is exemplarily only and that the material of spring region 336 does not have to extend into load beam region 338. Regardless of the type of load beam construction, such as those discussed above, suspension assemblies transfer the change in load force from a spring region to a load point 242 in a similar fashions.

Servo control circuitry, located in, for example circuit 132 illustrated in FIG. 1, controls the position of a slider on a track of medium 112. However, the accuracy and speed at which a slider is positioned can be limited by undesirable flexibility in a suspension assembly, such as for example suspension assembly 322 of FIG. 3. While suspension assembly 322 should flex up and down along a z-axis 348 to allow slider 349 to follow the topography of the medium, suspension assembly 322 should be as stiff as possible in all other directions such that suspension assembly 322 does not deflect in those directions while the servo control circuitry attempts to keep or position slider 349 on a track. Any flexibility in directions other than that along z-axis 348 limits the frequency at which the servo control circuitry can operate. In other words, any position errors at frequencies above the bandwidth of the servo control circuit cannot be corrected. However, if frequencies of undesirable modes of deflection in a suspension (i.e., sway, bending, drum and torsion) are increased, the servo control circuitry can operate at a higher bandwidth which allows for more accurate positioning of slider 349.

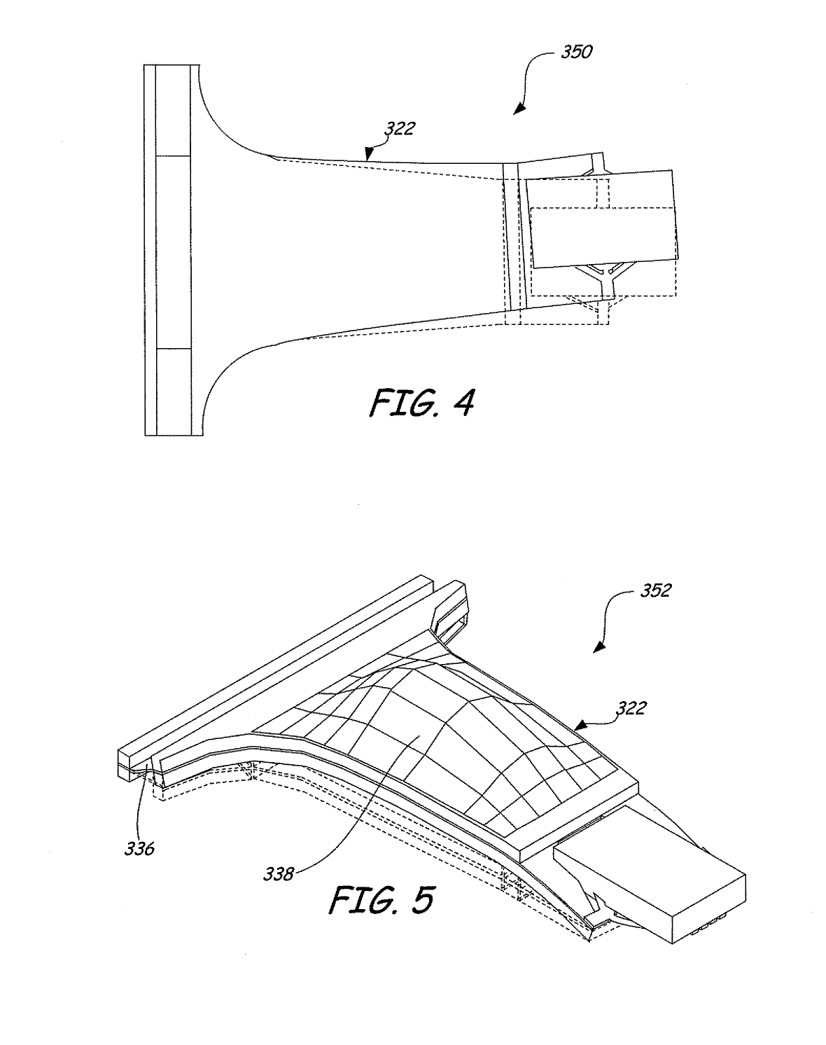

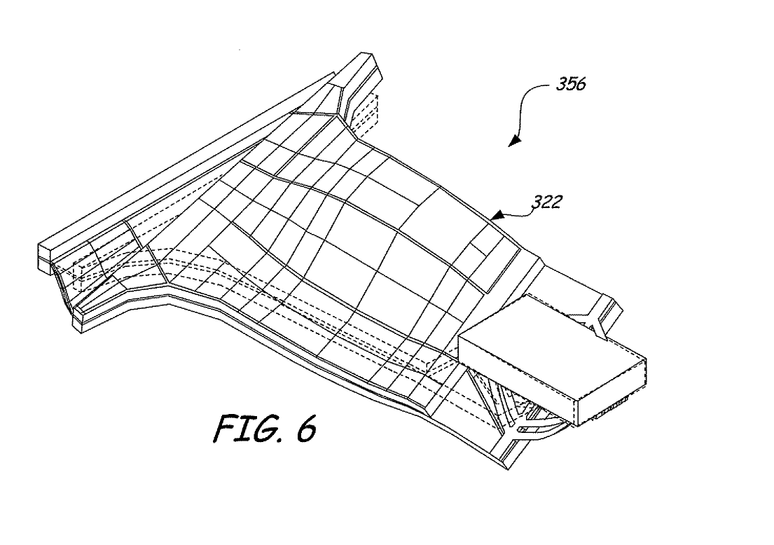

FIGS. 4, 5 and 6 illustrate bottom plan and bottom perspective views of suspension assembly 322 in three different undesirable deflection modes. FIG. 4 illustrates suspension assembly 322 in a sway mode 350. In the sway mode 350, suspension assembly 322 moves side to side relative to a fixed position indicated in dashed lines. FIG. 5 illustrates suspension assembly 322 in a bending mode 352. In the bending mode 352, bending occurs in both load beam region 338 and in spring region 336. The relative bending in load beam region 338 is illustrated relative to a fixed position indicated in dashed lines. FIG. 6 illustrates suspension assembly 322 in a torsion mode 356. In torsion mode 356, suspension assembly 322 twists about a longitudinal center of the suspension assembly. The relative torsion in suspension assembly 322 is illustrated relative to a fixed position indicated in dashed lines.

With reference to FIG. 3, one way to increase the frequency at the undesirable deflection modes to therefore cause the servo control circuitry to operate at a higher bandwidth is to reduce a length 358 (FIG. 3) of spring region 336. It should be noted that although reference is made to reduce a length 358 of spring region 336, the length of the spring region of other types of suspension assemblies can also be reduced, such as suspension assembly 222 of FIG. 2. The length 358 of spring region 336 is determined by the modulus of elasticity (i.e., a materials tendency to be deformed) of the material of spring region 336 and the desired vertical stiffness. The modulus of elasticity can also be referred to as Young's modulus of elasticity. By reducing the length 358 of spring region 336, the stiffness of spring region 336 is increased and the associated modal frequencies are also increased. However, the reduction in length 358 of spring region 336 also increases the vertical stiffness (i.e., stiffness along z-axis 348) which is through the load point. Such increase in the vertical stiffness provides slider 349 with a pre-load force that is more sensitive to disc vertical run out and medium height assembly tolerances.

One way to reduce the length of spring region 336 without increasing vertical stiffness is to select a material for spring region 336 that has a lower modulus of elasticity than that of conventional crystalline metallic materials traditionally used for spring region 336, such as stainless steel. For example, if length 358 of spring region 336 is reduced by a factor of 3 and the modulus of elasticity is reduced by the same factor, the vertical stiffness remains the same and the bending and torsional stiffness is 9 times stiffer and the undesirable deflection mode frequencies are increased by a factor of 3. However, such a result is not possible if the material selected for spring region 336 is selected from conventional crystalline metallic materials, other than stainless steel that are generally used in suspension assemblies of disc drives. Conventional crystalline metallic materials have yield strengths (fracture strengths) that are approximately proportional to their modulus of elasticity.

For example, the highest strength steels have a yield strength of approximately 1800 MPa and a modulus of elasticity of 207 GPa. The highest strength aluminum has a yield strength of approximately 450 MPa and a modulus of elasticity of 70 CPa. Since the yield strength of aluminum is lower than that of steel, aluminum can not easily be substituted for steel in spring region 336 in combination with reducing length 358 of spring region 336. A thickness 360 of spring region 336 is determined by the yield strength of the material of spring region 336, the pre-load force, a length 362 from base 334 to the load point and a width 364 of spring region 336. Such a substitution of lower yield strength for higher yield strength would require that the thickness 360 of spring region 336 be increased. An increase in thickness 360 of spring region 336 increases the stiffness of spring region 336 which also increases the vertical stiffness along axis 348. It should be noted that although reference is made to reduce a length 358 of spring region 336 and to increase a thickness 360 of spring region 336, the description also applies to changing the length and thickness of the spring region of other types of suspension assemblies, such as suspension assembly 222 of FIG. 2.

Therefore, in some embodiments of the disclosure, a spring region is at least partially formed from non-conventional spring region materials that demonstrate a ratio of modulus of elasticity to yield strength that is less than the ratio of modulus of elasticity to yield strength of conventional spring region materials, such as stainless steel. One such group of non-conventional materials that demonstrate these properties includes metallic glasses (i.e., amorphous alloys). Metallic glasses are special metal alloy systems which when cooled from the molten state rapidly enough do not crystallize, but solidify into an amorphous or glassy state. Although the disclosure describes in detail the selection of metallic glass as a non-conventional spring region material below, it should be noted that other types of non-conventional spring region materials can also be selected. For example, polymers, such as polyimides, have ratios of modulus of elasticity to yield strength that are similar or superior to that of the metallic glasses and can be used for a spring region of a suspension assembly.

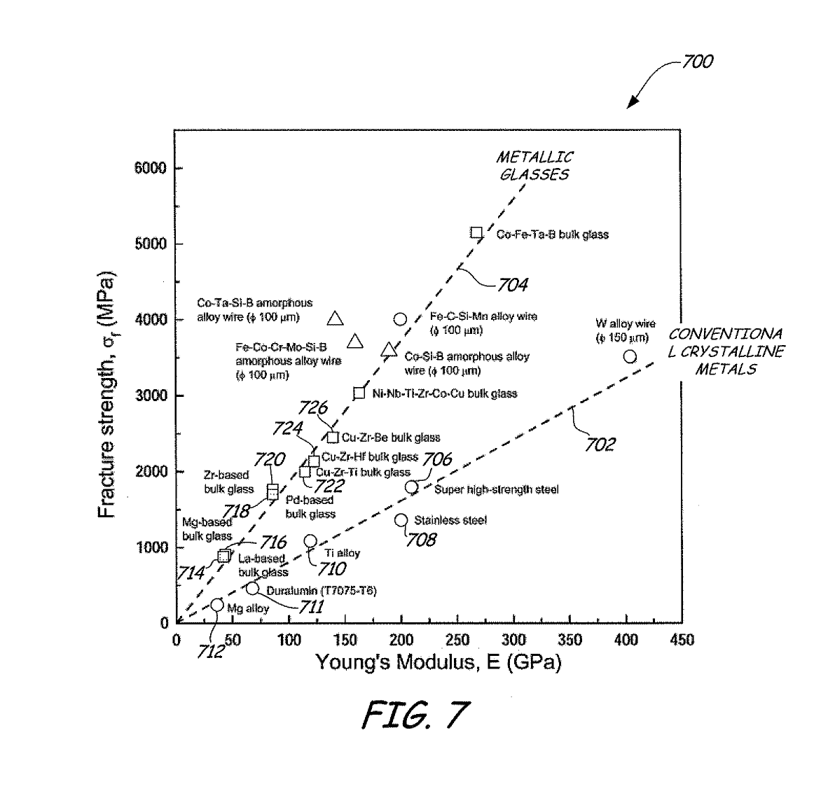

FIG. 7 is a plot 700 illustrating the relationship between yield strength (i.e., fracture strength) and Young's modulus of elasticity for conventional disc drive materials and metallic glasses. FIG. 7 illustrates a slope 702 that roughly approximates the relationship between the modulus of elasticity and yield strength for conventional crystalline metals. The approximate ratio of modulus of elasticity to yield strength indicated by slope 702 is approximately 123. FIG. 7 also illustrates a slope 704 that roughly approximates the relationship between the modulus of elasticity and yield strength for metallic glasses. The approximate ratio of modulus of elasticity to yield strength indicated by slope 704 is approximately 53. As illustrated by slopes 702 and 704 in FIG. 7, the metallic glasses have approximately 0.4 times the modulus of elasticity when compared to conventional crystalline metals of the same yield strength. Therefore, the ratio of modulus of elasticity to yield strength of metallic glasses is less than the ratio of modulus of elasticity to yield strength of conventional disc drive crystalline metals.

Examples of conventional crystalline metals traditionally used in suspension assemblies include alloyed steel, stairless steels, titanium alloys and magnesium alloys. Typical properties of alloyed steels include a modulus of elasticity of 190-210 GPa and a yield strength of 366-1793 MPa. Such alloyed steels, therefore, have a ratio of modulus of elasticity to yield strength of approximately 110 to 500. In FIG. 7, the illustrated super high strength steel data point 706 includes a ratio of modulus of elasticity to yield strength of approximately 120. Typical properties of stainless steel include a modulus of elasticity of 190-210 GPa and a yield strength of as great as 1300 MPa. Such stainless steels, therefore, have a ratio of modulus of elasticity to yield strength of approximately 150. In FIG. 7, the illustrated stainless steel data point 708 includes a ratio of modulus of elasticity to yield strength of approximately 130. Typical properties of titanium alloys include a modulus of elasticity of approximately 120 GPa and a yield strength of 1000 MPa. Such titanium alloys, therefore, have a ratio of modulus of elasticity to yield strength of approximately 120. In FIG. 7, the illustrated titanium alloy data point 710 includes a ratio of modulus of elasticity to yield strength of approximately 110. Typical properties of aluminums include a modulus of elasticity of approximately 60 GPa and a yield strength of approximately 400 MPa. Such aluminums, therefore, have a ratio of modulus of elasticity to yield strength of approximately 150. In FIG. 7, the illustrated Duralumin (T7075-T6) data point 711 includes a ratio of modulus of elasticity to yield strength of approximately 155. Typical properties of magnesium alloys include a modulus of elasticity of 45 GPa and a yield strength of 80-250 MPa. Such magnesium alloys, therefore, have a ratio of modulus of elasticity to yield strength of approximately 180-560. In FIG. 7, the illustrated magnesium alloy data point 712 includes a ratio of modulus of elasticity to yield strength of approximately 190.

Examples of different types of metallic glasses that can be selected for use in a spring region of a suspension assembly include a number of different alloy systems based on metals such as at least one of lanthanum (La), magnesium (Mg), chromium (Cr), zirconium (Zr), palladium (Pd), iron (Fe), cobalt (Co), nickel (Ni), molybdenum (Mb), tantalum (Ta) and copper (Cu) that can be alloyed with at least one of carbon (C), phosphorus (P), boron (B), aluminum (Al) and silicon (Si). These metallic glasses contain different kinds of atoms of significantly different sizes, which lead to low free volume and therefore higher viscosity than other crystalline metals and alloys in a molten state. The viscosity prevents the atoms from moving enough to form an ordered lattice. The material structure also results in low shrinkage during cooling and resistance to plastic deformation. The absence of grain boundaries, the weak spots of crystalline materials, leads to better resistance to wear and corrosion. These glassy metals are also much tougher and less brittle than oxide glasses and ceramics. The most significant contributions to the formation of these glassy metals are atomic size mismatch, high negative heat of mixing and multi-component alloy systems. Although metallic glasses can more easily be formed into very thin strips of material, metallic glasses can also be formed into thicker layers of material of greater than one millimeter. Thicker metallic glasses are called bulk metallic glasses.

Specific examples of metallic glasses that can be selected for use in a spring region of a suspension assembly are illustrated in FIG. 7 and include various alloys systems using elements as described above. For example, lanthanum-based metallic glass illustrated in FIG. 7 as data point 714 includes a ratio of modulus of elasticity to yield strength of approximately 47. Other examples include magnesium-based metallic glass illustrated in FIG. 7 as data point 716 that includes a ratio of modulus of elasticity to yield strength of approximately 49, palladium-based metallic glass illustrated in FIG. 7 as data point 718 that includes a ratio of modulus of elasticity to yield strength of approximately 50, zirconium-based metallic glass illustrated in FIG. 7 as data point 720 that includes a ratio of modulus of elasticity to yield strength of approximately 48, copper-zirconium-based metallic glasses illustrated in FIG. 7 as data points 722, 724 and 726 having ratios of modulus of elasticity to yield strength ranging between 57 and 59. Other example metallic glass or amorphous alloys are illustrated, such as cobalt-based, iron-based and nickel based amorphous alloys.

Of the various examples of metallic glasses in FIG. 7, particular examples have material properties well suited for selection for a spring region of suspension assembly. For example, the lanthanum-based, palladium-based and zirconium-based metallic glasses seem to be highly suitable for corrosion resistance, which is required for a spring region in a suspension assembly. In addition, the cobalt-tantalum-silicon-boron metallic glass having a ratio of modulus of elasticity to yield strength of 35 and the iron-cobalt-chromium-molybdenum-silicon-boron metallic glass having a modulus of elasticity to yield strength of 43 both demonstrate superior mechanical properties suitable for selection for a spring region of a suspension assembly.

With reference to various ratios of modulus of elasticity to yield strength of conventional crystalline metals and ratios of modulus of elasticity to yield strength of metallic glasses that were discussed above, it is pointed out that the material selected for the spring region of a suspension assembly includes a ratio of modulus of elasticity to yield strength of less than 100. When taking into consideration the cobalt-tantalum-silicon-boron metallic glass and the copper-based metallic glasses, the material selected for the spring region of a suspension assembly includes a ratio of modulus of elasticity to yield strength of between 30 and 70. In particular, the material selection for the spring region of a suspension assembly should correspond with the slope 804 illustrated in FIG. 8 of an approximate ratio of modulus of elasticity to yield strength of a metallic glass as being approximately 50 or less.

In other embodiments of the disclosure, a load beam region, such as load beam region 238 of FIG. 2 and load beam region 338 of FIG. 3, includes at least a first material that has a first ratio of modulus of elasticity to yield strength, A spring region, such as spring region 236 of FIG. 2 and spring region 336 of FIG. 3, includes a second material that has a second ratio of modulus of elasticity to yield strength. In this embodiment, the second ratio of the second material is less than the first ratio of the first material.

For example, the first material of the load beam region can be selected from the convention crystalline metals illustrated along slope 702 of FIG. 7, which have a modulus of elasticity to yield strength ratio of approximately 123. A more detailed description of the materials generally located along slope 702 are described above. In another example, the second material of the spring region can be selected form the metallic glasses illustrated along slope 704 of FIG. 7, which have a modulus of elasticity to yield strength ratio of approximately 53. A more detailed description of the materials generally located along slope 704 are described above. It should be noted, however, that the first material and the second material are not limited to selections from convention crystalline metals and metallic glasses, respectively. The first material and the second material can be selected from various types of materials as long as the second ratio of the second material is less than the first ratio of the first material. For example, a polymer, such as a polyimide, can be used for a spring region of a suspension assembly.

Referring back to FIGS. 4-6, when suspension assembly 322 is formed with conventional crystalline metals, such as stainless steel, the undesirable deflection modes have frequencies that need to be increased in order to increase the operational bandwidth of the servo control circuitry, which allows for more accurate position of slider 349.

One example includes spring region 336 first selected to be a conventional crystalline metal of a high strength copper alloy having a modulus of elasticity of 131 GPa. Spring region 336 is then selected to be an arbitrary metallic glass that has the same yield strength as the high strength copper alloy and a modulus of elasticity that is 0.4 times the modulus of elasticity of the high strength copper alloy or 52.4 GPa. In addition, the length 358 of spring region 336 was shortened by a factor of 0.4 to keep the same vertical stiffness along z-axis 348. The frequency results of this example are recorded below:

| | |
|---|---|
| Spring region | Spring region |
| at a modulus | at a modulus |
| of 131 GPa | of 52.4 GPa |

| | Mode | Frequency | Mode | Frequency |
|---|---|---|---|---|
| Mode # | Shape | (KHz) | Shape | (KHz) |
| 1 | Bending | 17.7 | Sway | 25.0 |
| 2 | Torsion | 20.7 | Bending | 26.3 |
| 3 | Sway | 29.1 | Torsion | 40.2 |

With spring region 336 selected to have a modulus of elasticity of 131 GPa, the first mode or lowest mode (in the shape of a bending mode 350 as illustrated in FIG. 4) has a frequency of 17.7 KHz, the second mode (in the shape of a torsion mode as illustrated in FIG. 6) has a frequency of 20.7 KHz and the third mode (in the shape of a sway mode as illustrated in FIG. 5) has a frequency of 29.1 KHz. With spring region 336 selected to have a modulus of elasticity of 52.4 GPa, the first mode or lowest mode (in the shape of sway mode 350 as illustrated in FIG. 4) has a frequency of 25.0 KHz, the second mode (in the shape of a bending mode 352 as illustrated in FIG. 5) has a frequency of 26.3 KHz and the third mode (in the shape of a torsion mode 356 as illustrated in FIG. 6) has a frequency of 40.2 KHz. As discussed above, the lowest (or first resonant mode) increased by 41% from 17.7 KHz to 25 KHz.

It is to be understood that even though numerous characteristics and advantages of various embodiments of the invention have been set forth in the foregoing description, together with details of the structure and function of various embodiments, this disclosure is illustrative only, and changes may be made in detail, especially in matters of structure and arrangement of parts within the principles of the disclosure to the full extent indicated by the broad general meaning of the terms in which the appended claims are expressed For example, the particular elements may vary depending on the type of construction of a suspension assembly while maintaining substantially the same functionality without departing from the scope and spirit of the present invention. In addition, although the preferred embodiment described herein is directed to a suspension assembly for a disc drive, it will be appreciated by those skilled in the art that the teachings of the present invention can be applied to other types of storage systems, without departing from the scope and spirit of the present invention.

What is claimed is:

1. A suspension comprising:
a base;
a load beam region; and
a spring region positioned between the base and the load beam region, the spring region including a material having a ratio of modulus of elasticity to yield strength that is about less than 100.

2. The suspension of claim 1, wherein the material included in the spring region comprises a ratio of modulus of elasticity to yield strength that is between approximately 30 and 70.

3. The suspension of claim 2, wherein the material included in the spring region comprises a ratio of modulus of elasticity to yield strength that is approximately less than or equal to 50.

4. The suspension of claim 1, wherein the load beam region comprises a crystalline metal.

5. The suspension of claim 1, wherein the spring region is at least partially formed of a metallic glass.

6. The suspension of claim 1, wherein the load beam region comprises a first material having a first ratio of modulus of elasticity to yield strength and the spring region comprises a second material having a second ratio of modulus of elasticity to yield strength, wherein the second ratio is less than the first ratio.

7. The suspension of claim 1, wherein the load beam region comprises a laminated structure.

8. A suspension comprising:
a base;
a load beam region; and
a flexible region positioned between the base and the load beam region, the spring region is at least partially formed of a metallic glass.

9. The suspension of claim 8, wherein the metallic glass of the flexible region has a ratio of modulus of elasticity to yield strength that is about less than 100.

10. The suspension of claim 8, wherein the metallic glass of the flexible region comprises a ratio of modulus of elasticity to yield strength that is between approximately 30 and 70.

11. The suspension of claim 10, wherein the metallic glass of the flexible region comprises a ratio of modulus of elasticity to yield strength that is approximately less than or equal to 50.

12. The suspension of claim 8, wherein the load beam region is at least partially formed of a crystalline metal.

13. The suspension of claim 8, wherein the load beam region comprises a first material having a first ratio of modulus of elasticity to yield strength and the metallic glass of the spring region has a second ratio of modulus of elasticity to yield strength, wherein the second ratio is less than the first ratio.

14. The suspension of claim 8, wherein the load beam region comprises a laminated structure having a core formed between a pair of metallic skins.

15. A suspension comprising:
a base;
a load beam region including a first material having a first ratio of modulus of elasticity to yield strength; and
a spring region positioned between the base and the load beam region, the spring region including a second material having a second ratio of modulus of elasticity to yield strength, wherein the second ratio is less than the first ratio.

16. The suspension of claim 15, wherein the second ratio of the second material of the spring region is less than 100.

17. The suspension of claim 16, wherein the second ratio of the second material of the spring region is between approximately 30 and 70.

18. The suspension of claim 17, wherein the second ratio of the second material of the spring region is approximately less than or equal to 50.

19. The suspension of claim 15, wherein the load beam region is at least partially formed of a crystalline metal.

20. The suspension of claim 15, wherein the spring region is at least partially formed of a metallic glass.
